(19) United States
(12) Patent Application Publication
(10) Pub. No.: US 2024/0202742 A1
(43) Pub. Date: Jun. 20, 2024

(54) SYSTEM FOR ENVIRONMENTAL IMPACT COMPENSATION

(71) Applicant: SAP SE, Walldorf (DE)

(72) Inventor: Rouven Krebs, Roemerberg (DE)

(21) Appl. No.: 18/065,779

(22) Filed: Dec. 14, 2022

(51) Int. Cl. G06Q 30/018

(52) U.S. Cl. CPC G06Q 30/018

(57) ABSTRACT

Computer-readable media, methods, and systems are disclosed for compensating for an environmental impact of a portion of a network or datacenter. A system may collect data from at least one source to create a system model of the network or datacenter having a plurality of elements, and determine the amount of energy consumed by at least one element of the plurality of elements and an environmental impact thereof by an analyzer. In order to mitigate the environmental impact, the system may input a target compensation amount into a compensation engine for the at least one element, calculate a derived compensation for at least one additional element of the plurality of elements. and input a system target compensation amount into the compensation engine for the entire system. If the derived compensation is less than the system target compensation amount, the system may provide a first compensation suggestion to a user to compensate for a remaining energy amount.

### TECHNICAL FIELD

Embodiments generally relate to an environmental impact system, and more particularly to a system for determining a carbon footprint for a datacenter and providing compensation therefor.

Information technology datacenters consume a high amount of energy that often maps to fossil fuels. From 2015 to 2020, the energy consumption of European datacenters increased by 24% and is expected to continue to grow by 3.5-5% each year. Overall, 6 billion tons of carbon dioxide was produced by European datacenters in 2020. The global average annual carbon footprint per person is about 4 tons. A carbon footprint is the total amount of greenhouse gases (including carbon dioxide and methane) that are generated by one's actions. The actual reduction of resources (especially for climate) is also of high interest. Besides the reduction of ongoing pollution by carbon dioxide, the compensation of a carbon footprint and the actual hardware resources production footprint is also of interest. The environmental impact is important not just for carbon dioxide but also for other aspects like water.

### SUMMARY

Disclosed embodiments address the above-mentioned problems by providing one or more non-transitory computer-readable media storing computer-executable instructions that, when executed by a processor, perform a method for compensating for an environmental impact of a datacenter, the method including: collecting data from at least one source to create a system model of the datacenter having a plurality of elements; determining, by an analyzer, the amount of energy consumed by at least one element of the plurality of elements and an environmental impact thereof; in order to mitigate the environmental impact, inputting a target compensation amount into a compensation engine for the at least one element; calculating a derived compensation for at least one additional element of the plurality of elements; and inputting a system target compensation amount into the compensation engine for the entire system; wherein if the derived compensation is less than the system target compensation amount, providing a first compensation suggestion to a user to compensate for a remaining energy amount.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present teachings will be apparent from the following detailed description of the embodiments and the accompanying drawing figures.

### BRIEF DESCRIPTION OF THE FIGURES

Embodiments are described in detail below with reference to the attached drawing figures, wherein:

FIG. 1 illustrates an exemplary metamodel having a transfer function.

FIG. 2 illustrates an exemplary landscape model including elements of a virtual infrastructure.

FIGS. 3A and 3B illustrate two halves of a more detailed landscape model with multiple elements.

FIG. 4 illustrates an embodiment of an exemplary detailed landscape model including associated compensation data.

FIG. 5 depicts an embodiment of exemplary system components.

FIG. 6 illustrates a sample computing device architecture for implementing various aspects described herein.

The drawing figures do not limit the present teachings to the specific embodiments disclosed and described herein. The drawings are not necessarily to scale, emphasis instead being placed upon clearly illustrating the principles of the disclosure.

### DETAILED DESCRIPTION

Using virtualized environments (VM, network, storage, etc.) was an essential step in the evolution of IT to reduce management overhead and to increase resource utilization. Finally, this direction led to cloud computing where hardware became virtualized, and many customers operate their systems on a shared environment provided by a third party. This offers chances to reduce costs by running systems only when needed (since resources are consumed on a time rental basis) and reduces administrative overhead.

However, virtualization makes it challenging to attribute a certain energy consumption to any particular process or virtual machine (VM) running on a hardware together with many other processes or VMs. It becomes even more complex with respect to volumes or network related entities. In addition, several VMs may together serve another higher-level purpose, such as one system including several processes running on different VMs. A single VM may even serve multiple systems. A system might be used by several clients and various organizational units. Furthermore, a system might be rescaled continuously to reduce costs. In an embodiment, a system may be a logical combination of processes that serve a common goal and each process may be an instance of the same program logic or different program logic. In an embodiment, a system may comprises a database instance, application servers, and a central instance/service.

In cloud computing determining energy consumption is even more challenging, since the provider is another legal entity and the actual customers do not have native access to the hardware or any datacenter details. Furthermore, the flexible usage of resources makes it difficult to calculate the actual resource consumption or energy consumption of a system level.

Breaking this information down to individual business processes, or even organization units is difficult. In some cases, one may want to track the environmental footprint of a product including its associated IT processes. In addition, these processes might span across multiple systems and processes that bridge the gap, for example, a product span across multiple IT processes.

This disclosure allows customers to compensate and track their environmental footprint of IT systems. Specifically, customers can track and compensate for all IT resources or specific parts. In an embodiment, analysis may be conducted based on an organizational unit or a product line. Thus, customers can specifically control how and what to compensate.

The disclosure allows for a calculation of the CO2 footprint for various elements such as business processes or organizational units, and provides automation that compensates for these resources if intended by the user. For the actual calculation, transfer functions may be applied to a model, reflecting all types of granularity (from hardware to organization units). For the compensation, an engine uses this data and executes measures or provides a user with suggestions to neutralize the CO2.

One can collect data from various layers within the described environment in order to build a model containing the elements from infrastructure to systems and business processes. Some layers of the model have knowledge of their CO2 consumption. Based on this model, it is possible to calculate the CO2 footprint for related entities with help of transfer functions.

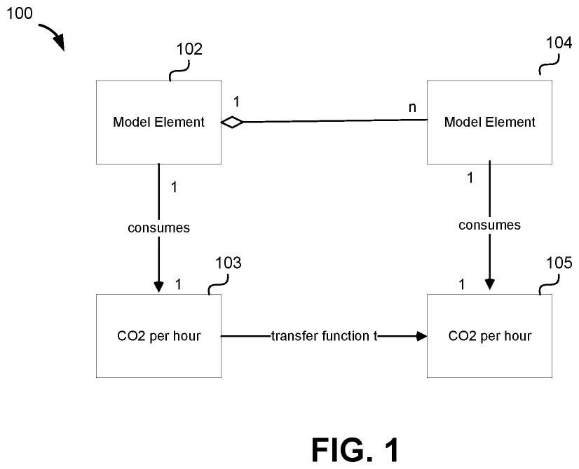

FIG. 1 shows an exemplary metamodel 100 having two model elements 102, 104. Model element 104 is a child of model element 102. For parent element 102, a CO2 production per hour 103 is known. A given transfer function t allows one to derive a CO2 production per hour 105 for the child elements, such as model element 104. Depending on the measurement type of the CO2 (per hour, per work), relation type and element type, different functions need to be applied. Even for the same combination of parameters, there might be various functions available to reflect different business needs. In some cases, additional parameters such as performance data might also be needed. In one embodiment, a model element may be a virtual machine. In one embodiment, the function may be:

(CO2PerHour:kg, NumberOfChild:int)→CO2PerHour:kg t: or

(CO2PerHour:kg, cpuCycCurrentChild:long, cpuCycParent:long)→CO2PerHour:kg t:

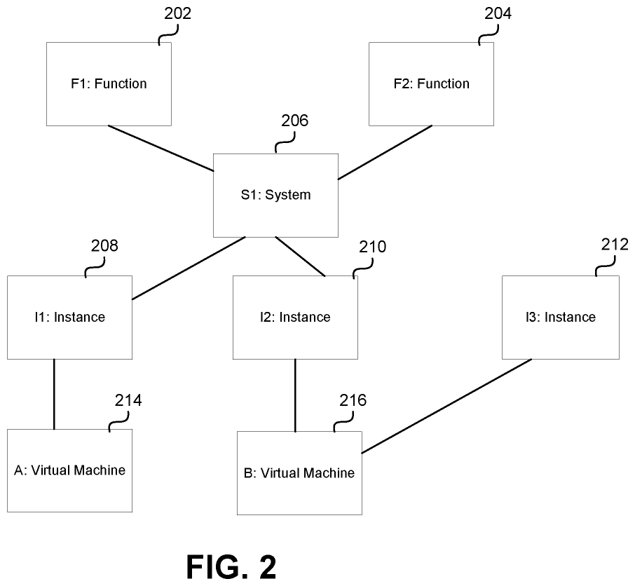

In an example, one model element could be a VM serving multiple application instances that belong to dedicated systems executing multiple functions as shown in the FIG. 2. If the CO2 produced per kWh is known for each VM, and the actual consumed kWh is a value that can be monitored and collected to serve as historical data for a certain timeframe under analysis, then the CO2 consumption can be determined.

In FIG. 2, there are two functions F1 and F2, denoted by elements 202, 204. System S1 is denoted by element 206. System S1 may have multiple instances, such as instances 11, 12, 13, denoted by elements 208, 210, 212. The instances may run on multiple virtual machines, such as virtual machine A and B, denoted by elements 214 and 216.

In an example, virtual machine A consumes 4.0 kWh/day. Thus, A=4.0 kWh/day*250 g/kWh=1000 g CO2 per day (based on assumption about energy mix). Virtual machine B consumes 2.0 kWh/day. Thus. B=2.0 kWh/day*250 g/kWh=500 g CO2 per day (based on assumption about energy mix). For one process the following measurements can be made: instance I1 performs 800 CPU cycles per day, instance I2 performs 300 CPU cycles per day, and instance I3 performs 700 CPU cycles per day. Function F1 performs 500 executions per day and function F2 performs 1000 executions per day.

Functions executed on the system might also be measured by CPU cycles or other resource related metrics, such as function parametrizations or performance related metrics such as the sum of all response times. Also, the instances load might be based on any performance parameters. Alternatively, the instances load can also be derived by dividing the VMs CO2 footprint by the number of instances. Furthermore, different approaches to measure CO2 are contemplate (e.g., per cycle, per MB memory allocated etc.).

The following calculation can then be performed:

consumption(A)=1000 g t(I1):

consumption(B)*cycles(I2)/(cycles(I2)+cycles(I3))=500g*(300/300+700)=150 g t(I2):

t(I1)+t(I2)=1150 g t(S1):

t(S1)*executions(F1)/(executions(F1)+executions(F2))=1150 g*(500/(500+1000))˜383 g t(F1):

t(S1)*(executions(F2)/(executions(F1)+executions(F2))=1150 g*(1000/(500+1000))˜767 g t(F2):

As a result, the CO2 consumption per day is determined for a concrete part of functionality within the system S1. In an embodiment, these calculations are executed by the analyzing component, such as CO2 analyzer 520, and kept within an analyzer specific model, such as CO2 model 512.

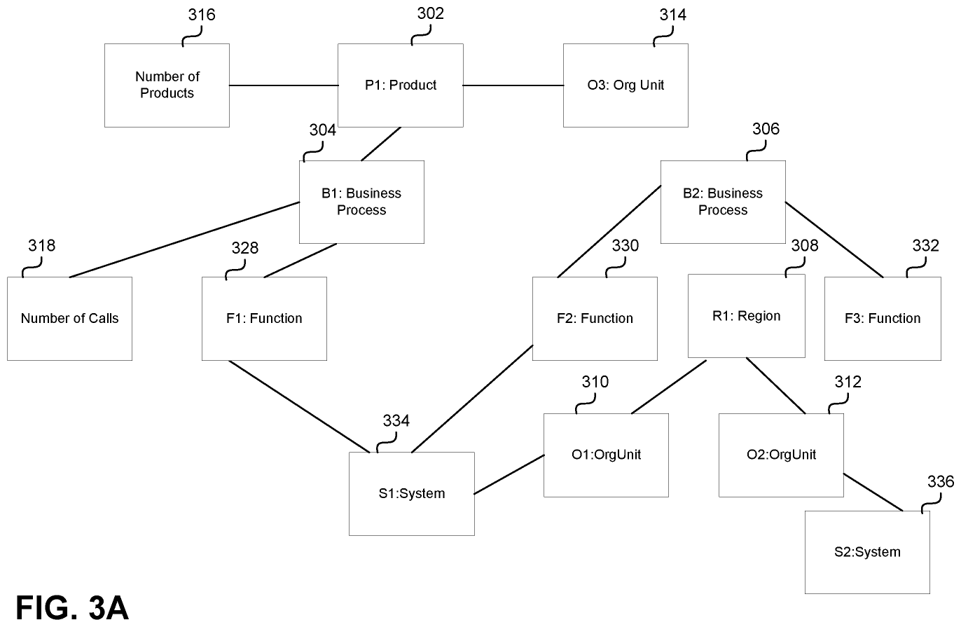

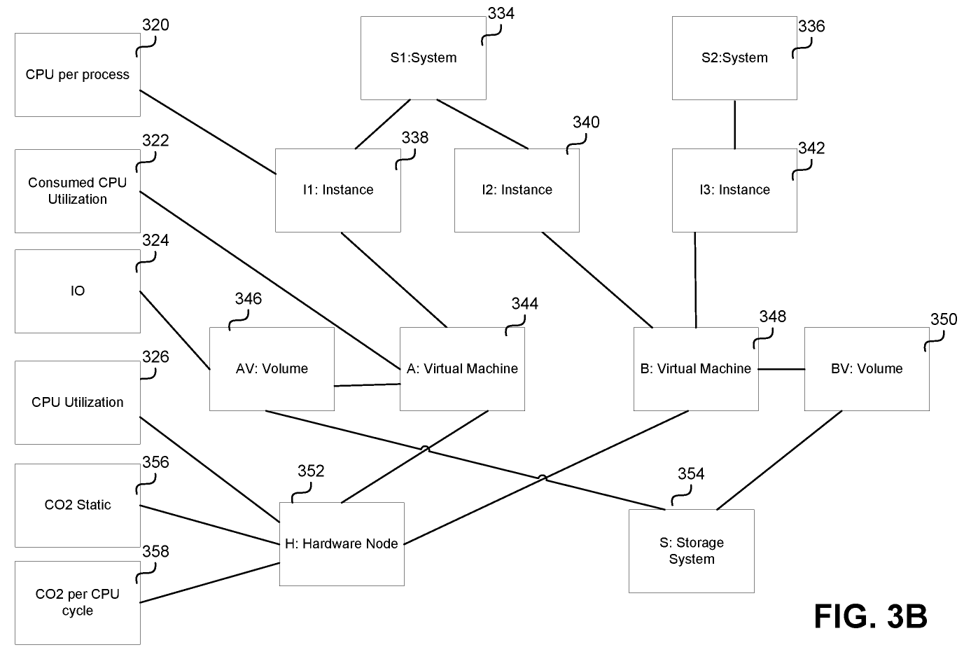

To map these resource consumptions to business processes, organizational units, or even concrete products a more complex model is used, as shown in FIG. 3A-3B.

In FIGS. 3A-3B, the infrastructure components are illustrated by virtual machine A 344, virtual machine A volume AV 346, virtual machine B 348, virtual machine B volume BV 350, hardware node H 352, and storage system S 354. The software components (deployment view on an application) are represented by instances I1 338, I2 340, and I3 342. Elements 302, 304, and 306 represent product related data P1, including the business processes B1, B2 that belong thereto, respectively. Elements 328, 330, and 332 represent technical functions provided by the systems (application internal aspects), such as executed functions F1, F2, F3. Elements 308, 310, 312, and 314 represent organizational aspects like organizational units, regions (to reflect legal aspects), or subsidiaries, etc. Elements 356 and 358 represent CO related data, which may be static and dynamic components (or could alternatively or additionally be energy, water, social impact or anything else to be compensates). Elements 316, 318, 320, 322, 324, and 326 represent measurements/probes that are used to calculate a contribution to the CO2 footprint, such as performance data. These elements provide real-time data that is more precise then using static model information, such as child element 104 of FIG. 1. For example, element 316 may represent the number of products and element 318 may represent the number of calls. Element 320 may represent the CPU per process by the instance I1 338. Element 322 may represent the consumed CPU utilization associated with the virtual machine A 344. Element 324 may represent the energy produced by numerous inputs/outputs (10) associated with the virtual machine A volume AV 346. For example, a storage contribution to the CO2 energy may be based on 10 per second (IOPS). In an example, if a storage system takes 18000 Wh and serves 100 k IOPS, an individual user using 50 k of the IOPS may be determined to take 900 Wh. Element 326 may represent the CPU utilization for the hardware node 352 to which it is connected. Element 356 may represent the static CO2 amount of energy produced by associated hardware node 352. Element 358 may represent the dynamic CO2 per CPU cycle amount of energy produced by associated hardware node 352. FIG. 3B is a continuation of FIG. 3A, wherein elements below the systems 334 and 336 are illustrated.

In addition, relationships are possible between many more element types. For example, an organization unit may also have a direct relation to VMs etc. as well as business processes in case the application layer could not be modelled with the required details. In one embodiment, compensation is on a business-related level, such as business processes, products, or organizational structures. In some embodiments, one may compensate on system level.

The compensation model itself may include different measures for how a compensation can be done (e.g., buying CO2 or energy certificates or planting trees). The compensation model can contain information for various scenarios such as (1) compensating ongoing CO2 consumption or (2) compensating one-time events like buying a new device that had to be produced. Furthermore, by continually tracking compensations, no duplicate compensation is made.

With respect to FIG. 3A, assuming organization unit O1 310 already compensated all its related resources, then system S1 334 has also already been completely compensated. Since product P1 302 and business process B1 304 is connected to system S1, they are already compensated as well. However, business process B2 306 is only partially compensated. Thus, in order to provide complete compensation for the landscape, a user may wish to also compensate business process B2 306.

Thus, the compensation part of the system disclosed herein is responsible for triggering compensation activities, monitoring these compensation activities, and displaying transparency to a user on what is compensated and to what extent. The system disclosed herein also allows compensation of some aspects to only a certain percentage, and mixing of various compensation models. The model is enhanced with such additional information.

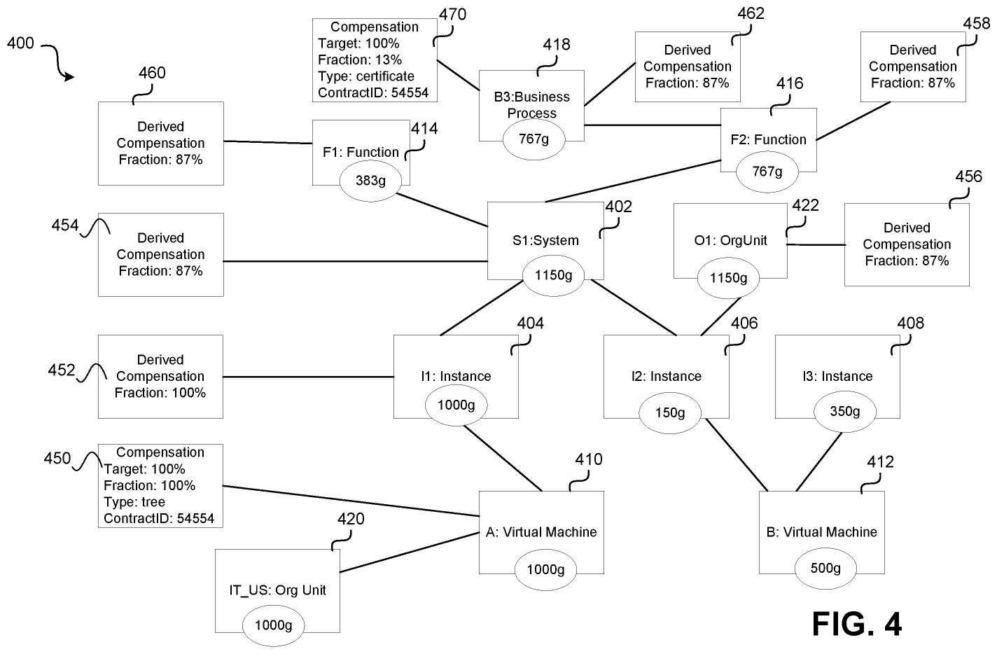

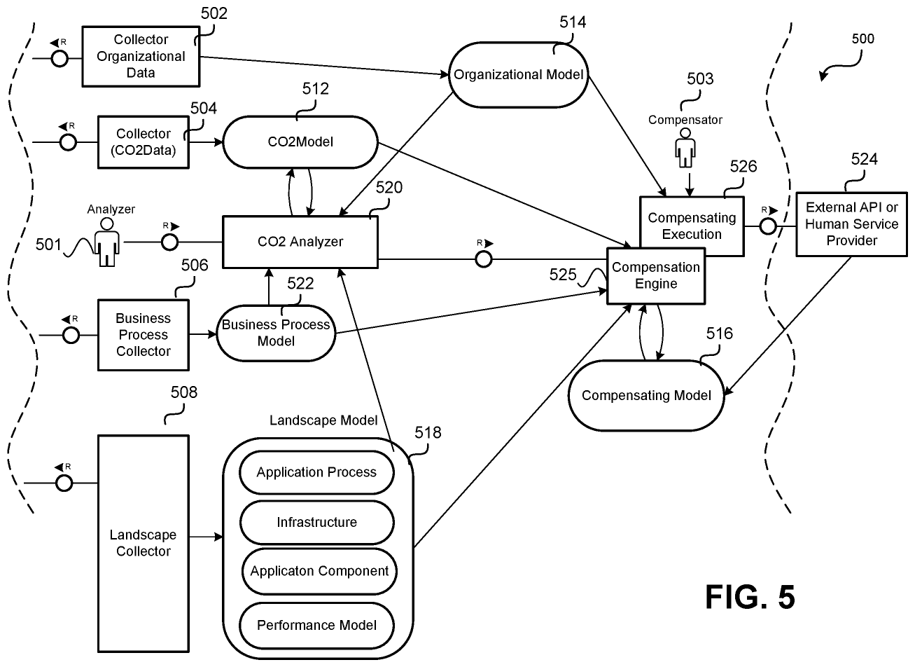

FIG. 4 illustrates an embodiment of a model 400 with calculations included. The actual, estimated, or calculated CO2 production is illustrated for each element. A CO2 analyzer 520, as illustrated in FIG. 5, can be used to determine this energy consumption/CO2 production. A compensation engine 525, as illustrated in FIG. 5, is provided to differentiate between the actual compensations and derived compensations.

FIG. 4 illustrates landscape model 400. Model 400 may include system S1 402, having 2 instances I1 404, I2 406 related thereto. Instance I1 404 may run on virtual machine A 410 and instance I2 406 may run on virtual machine B 412. A third instance I3 may also run on virtual machine B 412. Additionally, system S1 402 may have related functions F1 414 and F2 416. Function F2 may be related to business process B3 418. An organizational unit 420, such as IT_US, may be connected to virtual machine A 410 and another organizational unit O1 422 may be connected to instance I2 406.

In an example, organizational unit 420 may determine that they want to compensate for the energy consumption of virtual machine A 410 to which they are connected. CO2 analyzer 520 may determine that the environmental impact or carbon footprint of virtual machine A is 1000 g. A user at organizational unit 420 may determine how much of this impact they want to mitigate or compensate for. In this example, a user sets the target compensation at 100%, as seen in data 450. The fraction compensated here would then be 100%. A user can also choose how to provide such compensation, such as by planting a number of trees or buying a number of energy performance certificates, such as issued by the EU. The data may also include an identification, such as a contract ID number tied to the particular element of the model that is being compensated for. The compensation data 450 may be provided and/or calculated and/or predicted by the compensation engine 525.

Since the virtual machine A produces 1000 g of emissions and it is associated with instance I1 404, it can be derived that instance I1 404 also produces 1000 g. As mentioned above, instance I1 404 is one of two instances running on system S1 402. It can be determined (such as by CO2 analyzer 520) that system S1 402 produces 1150 g, thus the other instance I2 406 produces 150 g. Thus, the model 400 illustrates that instance I1 404 may have a derived compensation 452, which is a fraction of 100%. The model also illustrates that system S1 402 then has a derived compensation 454, which is a fraction of 87% (equal to 1000/1150). Organizational unit O1 422 also is determined to produce 1150 g, and the derived compensation 456 therefor is also a fraction of 87% because 1000 g was already compensated for. Virtual machine B 412 may also be associated with an emission production of 500 g, which is split into two instances I2 406 of 150 g and instance I3 408 of 350 g.

It can furthermore be determined how much energy consumption and emissions are associated with each function, such as F1 414 and function F2 416. In this exemplary model 400, function F1 may be associated with 383 g and function F2 may be associated with 767 g, which together add up to the system S1 402 production of 1150 g. The derived compensation 458 associated with function F2 416 may be a fraction of 87% because it is associated with system S1 402. Business process B3 418 may be associated with 767 g since it is related to function F2 416. Similarly, business process B3 418 then has a derived compensation 462 of a fraction of 87%. Additionally, function F1 414 may have a derived compensation 460 of a fraction of 87%. Then a compensation to be provided, in addition to the compensation provided at 450, may be determined at 470. Here the target compensation is 100% but there is a fraction of 13% that was not already compensated for (from the 87%). Thus, an additional compensation aspect must be added for the additional energy production added on top of the already compensated energy of instance I1 404. The additional 13% may be compensated, for example, by an energy certificate.

In an embodiment, compensation may be a user-initiated setting to compensate a certain model element. The compensation may be set to a particular percentage, such as 50%, and the compensation engine will regularly take actions to compensate the aspects based on latest monitoring data, structural changes, etc. Thus, a user can define a certain compensation target. In some embodiments compensation may be defined by the money spent, or the CO2 weight. In these cases, the fraction would be a dynamic value. In some cases, the goal might already be fulfilled to some extent by a derived compensation. In such a situation, the actual difference needs to be compensated (expressed as attribute fraction in FIG. 4).

A derived compensation, such as 452, 454, 456, 458, 460, or 462, is calculated based on the CO2 analyzer's results and already existing compensations. In the given example of FIG. 4, a user has determined that the organizational unit IT_US 420 will compensate all its hardware related resources by 100%. As such virtual machine A 410 has already been compensated. However, system S1 402 has only been compensated by 87%. Assuming there is a business need to make a business process B3 418 environmentally green, a user could add a compensation target of 100%. This would require adding an additional compensation of 13% at business process B3 418. The compensation engine 525 triggers measures or provides suggestions to a user to compensate the 13% additional amount and may reference these activities by an identified contract or other identifier. In an embodiment, the compensation engine 525 may also provide cost information etc. for the currently executed compensations.

In an embodiment, a user may set a target compensation for an organizational unit. In this case, the actual derived compensation would also apply to associated hardware resource, such as a virtual machine. For example, if the organizational unit produced 1000 g, then the associated virtual machine would be determined to produce 1000 g as well.

FIG. 5 depicts exemplary system components. System 500 may include the following components: collectors 504, 506, 508, 510, models 512, 514, 516, 518, CO2 analyzer 520, and compensation engine 525, as described below.

Collectors may include Organizational Data collector 502, CO2 data collector 504, business process collector 506, and landscape collector 508. Collectors fill the models with information from various sources such as Hyperscaler APIs, access to business enterprise resource planning (ERP) systems, IT management tools, performance monitoring tools, databases about CO2 footprint/production and CO2 manufacturing costs for new hardware, public IaaS APIs about current energy consumption/CO2 impact, application internal monitoring, external service providers that compensate CO2, etc. In some cases, a collector might be operated by a human user and some data might be entered manually. The collectors also set the elements in relation to each other. Collectors may also be automated to routinely collect data, such as based on a time parameter. Collectors may retrieve data in real time to provide continual monitoring of a system's energy usage.

Organizational data collector 502 may send a request for particular data, which may then be sent to organization model 514, which in turn may send data to CO2 analyzer 520 and compensation engine 525. CO2 data collector 504 may send a request for usage data related to consumed resources and resulting CO2 output. This data may be sent to CO2 model 512, which may send data to CO2 analyzer 520 and compensation engine 525. A user 501, such as an analyzer, may send a request to CO2 analyzer 520 for a particular output relating to the CO2 output of one or more elements of models 512, 514, 516, or 518. Business process collector 506 may send a request for particular data to input into a business process model 522, which may send data to CO2 analyzer 520 and compensation engine 525. Landscape collector 508 may send a request for data to input into landscape model 518, which may send data to CO2 analyzer 520 and compensation engine 525.

Models may include CO2 model 512, organization model 514, compensating model 516, landscape model 518, and business process model 522. The models ensure a semantic consistency of the data persisted. They reflect an aspect of the landscape and business processes and business structures and compensating action to an extent they are relevant for sustainability. Also, all these models serve a dedicated purpose, as they are connected to each other by references. In some examples there might be just one single unique model or any kind of combination. The content of the models has already been discussed above. Landscape model 518 may include application process, infrastructure, application component, and performance model.

The CO2 analyzer 520 continuously enhances/updates the CO2 model 512 with information about CO2 impact based on some starting points like known energy consumption for VMs and the energy mix of the power supply used in that specific datacenter. In some cases, data is directly retrieved via the collector's data about a certain CO2 impact of a VM. CO2 analyzer 520 also keeps the data to provide historical insights for the actual compensation. In some embodiments, the system may keep track of historical data and also predict nonlinear future resource consumptions, such as by using machine learning.

Compensation engine 525 may include a compensating execution element 526. A user 503, such as a compensator, may submit a request to compensation engine 525 to provide a compensation for a particular part of the system, such as one or more elements of models 512, 514, 516, 518 or 522. Compensation engine 525 uses historical data from the analyzer 520 to compensate backwards (compensating today for the exhaust from yesterday) and/or predicted data from the analyzer 520 for the future to compensate at the time of the CO2 creation. The compensation engine 525 furthermore continuously monitors the current/historical/predicted CO2 footprint in comparison to the given target. Based on this, compensation engine 525 updates the model's derived compensations and takes measures to maintain the target values. Action may include consuming external service providers. Users may adjust the decision taking algorithms for selection of compensations methods. External API or human service provider 524 may provide an input to the compensating model 516 and be connected to compensation engine 525.

The system described herein provides measures to automatically compensate for an environmental impact based on user defined targets. For example, if a hyperscaler offers to use compensated VMs, business processes that span into the on-premise world or non-compensated deployments will not be compensated. The current system allows for calculating and/or combining compensated/non-compensated resources dynamically. Furthermore, the current system allows for backtracking an intended compensation on higher business entities such as products down to the actual CO2 generating entities.

Combining detailed landscape information with CO2 analyzer 520, it is possible to derive a detailed view on CO2 contribution on various abstraction levels within an organization. Adding a compensation engine 525 allows a user to compensate the CO2 footprint on specific levels automatically, thereby avoiding double compensation and providing transparency.

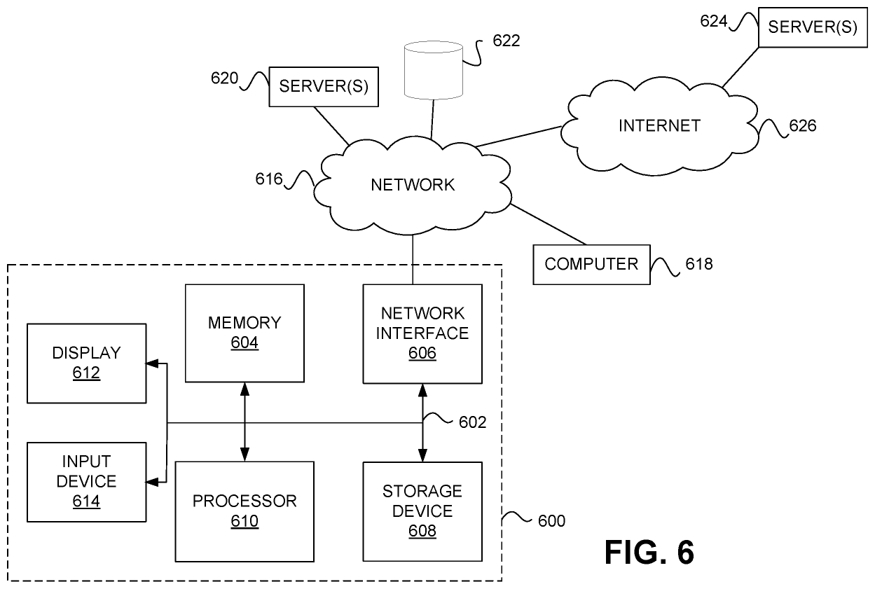

FIG. 6 is a diagram illustrating a sample computing device architecture for implementing various aspects described herein. Computer 600 can be a desktop computer, a laptop computer, a server computer, a mobile device such as a smartphone or tablet, or any other form factor of general- or special-purpose computing device containing at least one processor. Depicted with computer 600 are several components, for illustrative purposes. Certain components may be arranged differently or be absent. Additional components may also be present. Included in computer 600 is system bus 602, via which other components of computer 600 can communicate with each other. In certain embodiments, there may be multiple busses or components may communicate with each other directly. Connected to system bus 602 is processor 610. Also attached to system bus 602 is memory 604. Also attached to system bus 602 is display 612. In some embodiments, a graphics card providing an input to display 612 may not be a physically separate card, but rather may be integrated into a motherboard or processor 610. The graphics card may have a separate graphics-processing unit (GPU), which can be used for graphics processing or for general purpose computing (GPGPU). The graphics card may contain GPU memory. In some embodiments no display is present, while in others it is integrated into computer 600. Similarly, peripherals such as input device 614 is connected to system bus 602. Like display 612, these peripherals may be integrated into computer 600 or absent. Also connected to system bus 602 is storage device 608, which may be any form of computer-readable media, such as non-transitory computer readable media, and may be internally installed in computer 600 or externally and removably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface 606 is also attached to system bus 602 and allows computer 600 to communicate over a network such as network 616. Network interface 606 can be any form of network interface known in the art, such as Ethernet, ATM, fiber, Bluetooth, or Wi-Fi (i.e., the Institute of Electrical and Electronics Engineers (IEEE) 802.11 family of standards). Network interface 606 connects computer 600 to network 616, which may also include one or more other computers, such as computer 618, and network storage, such as cloud network storage. Network 616 is in turn connected to public Internet 626, which connects many networks globally. In some embodiments, computer 600 can itself be directly connected to public Internet 626.

In some embodiments, a machine learning model is provided in the context of a computer hardware and software architecture environment. In an embodiment, machine learning may include supervised learning and/or unsupervised learning. Supervised learning is defined by labeled datasets that are used to train algorithms into classifying data and/or predicting outcomes. Supervised learning may include classification algorithms and regression algorithms. Classification algorithms may include linear classifiers, support vector machines, decision trees, and random forest. Regression models include linear regression, logistic regression, and polynomial regression.

In an embodiment, the CO2 analyzer 520 and/or compensation engine 525 may provide an input into a supervised machine learning model. Such a supervised learning model may be used to output a prediction to a user, such as related to changes in the landscape in the cloud environment. For example, the machine learning model may provide an estimate of how much additional energy would be consumed if a new business process was added, and/or how to compensate for this additional energy consumption. In another example, the machine learning model may provide an estimate of how much energy would be saved by changing the operating parameters of a virtual machine. In another example, the machine learning model may provide an estimate of how much energy would be saved by adding solar energy or other environmentally-friendly energy sources to supplement or replace the current energy usage of a virtual machine.

Unsupervised learning models may be used for determining hidden patterns in data and include clustering, association, and dimensionality reduction. Clustering techniques assign similar data points into groups. The association method uses rules to find relationships between variables in a dataset. Dimensionality reduction may be used to reduce the number of data points to a manageable size when the number of features in a dataset is too large. In an embodiment, the knowledge graph model may provide an input into an unsupervised machine learning model. Such an unsupervised machine learning model may provide insights from the new data that were not contemplated by the user. For example, the machine learning model may provide a recommendation that performing particular business processes at a particular time may conserve resources. Machine learning may also be used as a transfer function or to build up the model initially and understand how the processes are related to the system as a whole. Thus, machine learning may be used for many aspects of the system including collectors, models and analyzers.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “computer-readable medium” refers to any computer program product, apparatus and/or device, such as for example magnetic discs, optical disks, memory, and Programmable Logic Devices (PLDs), used to provide machine instructions and/or data to a programmable processor, including a computer-readable medium that receives machine instructions as a computer-readable signal. The term “computer-readable signal” refers to any signal used to provide machine instructions and/or data to a programmable processor. The computer-readable medium can store such machine instructions non-transitorily, such as for example as would a non-transient solid-state memory or a magnetic hard drive or any equivalent storage medium. The computer-readable medium can alternatively or additionally store such machine instructions in a transient manner, for example as would a processor cache or other random-access memory associated with one or more physical processor cores.

Many different arrangements of the various components depicted, as well as components not shown, are possible without departing from the scope of the claims below. Embodiments have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims. Although described with reference to the embodiments illustrated in the attached drawing figures, it is noted that equivalents may be employed, and substitutions made herein without departing from the scope as recited in the claims. The subject matter of the present disclosure is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be understood by one skilled in the art and are intended to be captured within the scope of the present claims. Terms should not be interpreted as implying any particular ordering of various steps described unless the order of individual steps is explicitly described.

The following detailed description of embodiments references the accompanying drawings that illustrate specific embodiments in which the present teachings can be practiced. The described embodiments are intended to illustrate aspects in sufficient detail to enable those skilled in the art to practice the embodiments. Other embodiments can be utilized, and changes can be made without departing from the claimed scope. The following detailed description is, therefore, not to be taken in a limiting sense. The scope of embodiments is defined only by the appended claims, along with the full scope of equivalents to which such claims are entitled.

Having thus described various embodiments, what is claimed as new and desired to be protected by Letters Patent includes the following:

1. One or more non-transitory computer-readable media storing computer-executable instructions that, when executed by a processor, perform a method for compensating for an environmental impact of at least a portion of a network or datacenter, the method comprising:
collecting data from at least one source to create a system model of the network or datacenter having a plurality of elements;
determining, by an analyzer, an amount of a resource consumed by at least one element of the plurality of elements and an environmental impact thereof;
in order to mitigate the environmental impact, inputting a target compensation amount into a compensation engine for the at least one element;
calculating a derived compensation for at least one additional element of the plurality of elements; and
inputting a system target compensation amount into the compensation engine for the entire system;
wherein if the derived compensation is less than the system target compensation amount, providing a first compensation suggestion to a user to compensate for a remaining resource amount.

2. The non-transitory computer-readable media of claim 1, the method further comprising:
determining if a first compensation has been previously provided; and
if the first compensation has been provided, then determining what fraction the first compensation is relative to the target compensation amount for the system; and
providing a second compensation suggestion to the user to reach the system target compensation amount.

3. The non-transitory computer-readable media of claim 1, wherein the inputting the target compensation amount and/or inputting the system target compensation amount is performed by the user on a user interface.

4. The non-transitory computer-readable media of claim 1, wherein the compensation first suggestion comprises an action to mitigate the environmental impact of the resource consumption.

5. The non-transitory computer-readable media of claim 1, wherein the resource is energy, and the first suggestion comprises planting a tree or acquiring an energy certificate.

6. The non-transitory computer-readable media of claim 1, wherein the plurality of elements comprises: a virtual machine, an instance, a computer system, an organizational unit, a business process, a function, or a product.

7. The non-transitory computer-readable media of claim 1, wherein the resource is energy, and further comprising determining, by an analyzer, an amount of energy consumed by all of the plurality of elements in the system model and an environmental impact thereof, wherein the environmental impact is indicative of a carbon footprint of the network or datacenter.

8. A method for compensating for an environmental impact of at least a portion of a network or datacenter, the method comprising:
collecting data from at least one source to create a system model of the network or datacenter having a plurality of elements;
determining, by an analyzer, an amount of a resource consumed by at least one element of the plurality of elements and an environmental impact thereof;
in order to mitigate the environmental impact, inputting a target compensation amount into a compensation engine for the at least one element;
calculating a derived compensation for at least one additional element of the plurality of elements; and
inputting a system target compensation amount into the compensation engine for the entire system;
wherein if the derived compensation is less than the system target compensation amount, providing a first compensation suggestion to a user to compensate for a remaining resource amount.

9. The method of claim 8, further comprising: determining if a first compensation has been previously provided; and
if the first compensation has been provided, then determining what fraction the first compensation is relative to the target compensation amount for the system; and
providing a second compensation suggestion to the user to reach the system target compensation amount.

10. The method of claim 8, wherein the inputting the target compensation amount and/or inputting the system target compensation amount is performed by the user on a user interface.

11. The method of claim 8, wherein the compensation first suggestion comprises an action to mitigate the environmental impact of the resource consumption.

12. The method of claim 8, wherein the resource is energy, and the first suggestion comprises planting a tree or acquiring an energy certificate.

13. The method of claim 8, wherein the plurality of elements comprises: a virtual machine, an instance, a computer system, an organizational unit, a business process, a function, or a product.

14. The method of claim 1, wherein the resource is energy, and further comprising determining, by an analyzer, an amount of energy consumed by all of the plurality of elements in the system model and an environmental impact thereof, wherein the environmental impact is indicative of a carbon footprint of the network or datacenter.

15. A system for compensating for an environmental impact of at least a portion of a network or datacenter, the system comprising:
at least one processor; and
at least one non-transitory computer-readable media storing computer executable instructions that when executed by the at least one processor cause the system to carry out actions comprising:
collecting data from at least one source to create a system model of the network or datacenter having a plurality of elements;
determining, by an analyzer, an amount of a resource consumed by at least one element of the plurality of elements and an environmental impact thereof;
in order to mitigate the environmental impact, inputting a target compensation amount into a compensation engine for the at least one element;
calculating a derived compensation for at least one additional element of the plurality of elements; and
inputting a system target compensation amount into the compensation engine for the entire system;
wherein if the derived compensation is less than the system target compensation amount, providing a first compensation suggestion to a user to compensate for a remaining resource amount.

16. The system of claim 15, further comprising: determining if a first compensation has been previously provided; and
if the first compensation has been provided, then determining what fraction the first compensation is relative to the target compensation amount for the system; and
providing a second compensation suggestion to the user to reach the system target compensation amount.

17. The system of claim 15, wherein the inputting the target compensation amount and/or inputting the system target compensation amount is performed by the user on a user interface.

18. The system of claim 15, wherein the resource is energy, and the first suggestion comprises an action to mitigate the environmental impact of the energy consumption.

19. The system of claim 15, wherein the plurality of elements comprises: a virtual machine, an instance, a computer system, an organizational unit, a business process, a function, or a product.

20. The system of claim 15, wherein the resource is energy, and further comprising determining, by an analyzer, an amount of energy consumed by all of the plurality of elements in the system model and an environmental impact thereof, wherein the environmental impact is indicative of a carbon footprint of the network or datacenter.
